(19) United States
(12) Patent Application Publication
(10) Pub. No.: US 2018/0229841 A1
(43) Pub. Date: Aug. 16, 2018

(54) Laser-Guided UAV Delivery System

(71) Applicant: Wal-Mart Stores, Inc., Bentonville, AR (US)

(72) Inventor: Robert Cantrell, Herdon, VA (US)

(21) Appl. No.: 15/882,100

(22) Filed: Jan. 29, 2018

Related U.S. Application Data
(60) Provisional application No. 62/459,673, filed on Feb. 16, 2017.

(51) Int. Cl. B64C 39/02; B64D 9/00; G01S 17/10

(52) U.S. Cl. CPC B64C 39/024; B64D 9/00; B64C 2201/141; B64C 2201/128; G01S 17/102

(57) ABSTRACT

An automated laser guided UAV delivery system is discussed. A UAV carrying a physical object in a storage unit, autonomously aerially navigates towards a specified location. The UAV includes an inertial navigation system and a sensor and can detect, via the sensor, a laser transmission emitted on the surface of a specified location. The UAV can detect the frequency and pulse of the laser transmission to identify that it is the intended recipient of the laser transmission. The UAV can deliver the physical object from the storage unit onto the surface of the specified location on which the laser transmission is being emitted.

### CROSS-REFERENCE TO RELATED PATENT APPLICATIONS

This application claims priority to U.S. Provisional Application No. 62/459,673 filed on Feb. 16, 2017, the content of which is hereby incorporated by reference in its entirety.

### BACKGROUND

Unmanned Aerial Vehicles (UAVs) unload physical objects at specified location. Laser guidance can be used to indicate a specified delivery location.

### SUMMARY

In one embodiment, an unmanned aerial vehicle (UAV) delivery system includes a laser device configured to emit a laser transmission onto a surface of a specified location. The system further includes at least one autonomous UAV that includes an inertial navigation system, a sensor for detecting the laser transmission, and one or more storage units configured to store one or more physical objects. The system further includes a delivery module. The delivery module is executable on a mobile device equipped with a processor and configured to control the laser device to alter at least one of a frequency and pulse of the laser transmission so as to communicate with the e autonomous UAV. The UAV is configured to carry one or more physical objects in the one or more storage units, detect, via the sensor, the laser transmission on the surface of the specified location, identify one of the pulse and frequency of the laser transmission as being directed to the UAV, and deliver, based on the identifying, the one or more physical objects onto the surface of the specified location.

In one embodiment, an autonomous unmanned aerial vehicle (UAV) delivery method includes aerially navigating at least one autonomous UAV towards a specified location The autonomous UAV includes an inertial navigation system, a sensor, and one or more storage units. The method further includes carrying, with the UAV, one or more physical objects in the one or more storage units. The method further includes detecting, via the autonomous UAV, using the sensor, at least one of a pulse or frequency of the laser transmission on a surface of the specified location and delivering, from the autonomous UAV, the one or more physical objects onto the surface of the specified location based on the detecting.

In one embodiment, an unmanned aerial vehicle (UAV) delivery system includes a laser device configured to emit a laser transmission onto a surface of a suggested location. The system further includes at least one autonomous UAV that includes a sensor for detecting the laser transmission, and one or more storage units configured to store one or more physical objects. The system further includes a delivery module. The delivery module is executable on a mobile device equipped with a processor and configured to control the laser device to communicate with at least one autonomous UAV. The autonomous UAV is configured to carry one or more physical objects in the one or more storage units, detect, via the sensor, the laser transmission on the surface of the suggested location, identify another location within a predetermined distance of the suggested location as an alternate delivery location, transmit the alternate location to the delivery module, receive an approval of the alternate location from the delivery module unload, based on the approval, deliver the one or more physical objects at the alternate location instead of the suggested location.

### BRIEF DESCRIPTION OF DRAWINGS

Illustrative embodiments are shown by way of example in the accompanying drawings and should not be considered as a limitation of the present disclosure:

FIG. 1A is a block diagram illustrating an unmanned aerial vehicle (UAV) according to an exemplary embodiment;

FIG. 1B is a block diagram illustrating a unloading pad for a UAV in an exemplary embodiment;

FIG. 1C illustrates a laser guided delivery for a UAV according to an exemplary embodiment;

FIG. 2 is a block diagram illustrating an automated laser guided UAV delivery system according to an exemplary embodiment;

FIG. 3 is a block diagram illustrating an exemplary computing device suitable for use with an exemplary embodiment; and

FIG. 4 is a flowchart illustrating an exemplary process performed by an automated laser guided UAV delivery system in accordance with an exemplary embodiment;

### DETAILED DESCRIPTION

Described in detail herein is an automated laser guided UAV delivery system. A UAV carrying a physical object in a storage unit, autonomously aerially navigates towards a specified location. The UAV includes an inertial navigation system and a sensor. The UAV can detect, via the sensor, a laser transmission emitted on a surface of a specified delivery location. The UAV can detect the frequency and pulse of the laser transmission to determine that the transmission is intendend for the UAV. The UAV can deliver the physical object from the storage unit onto the surface of the specified location on which the laser transmission is being emitted based on the identifying.

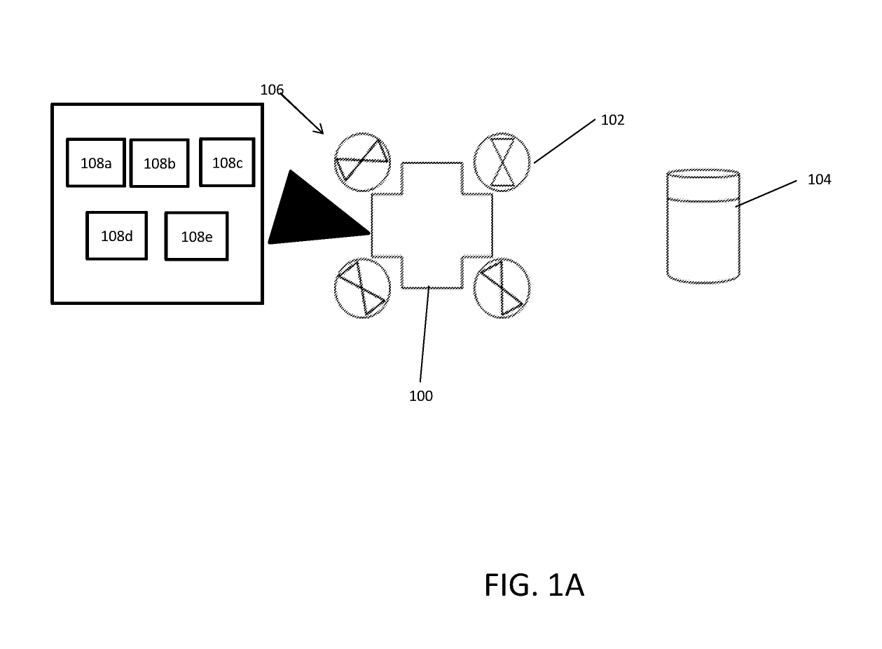

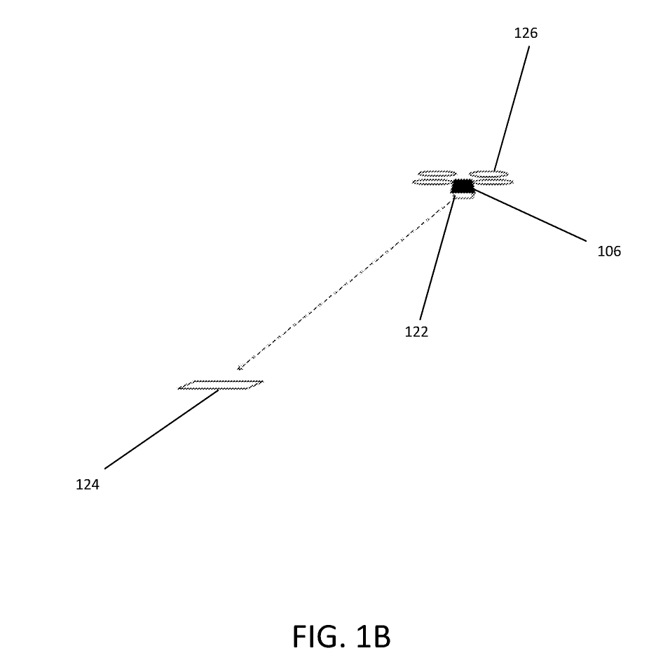

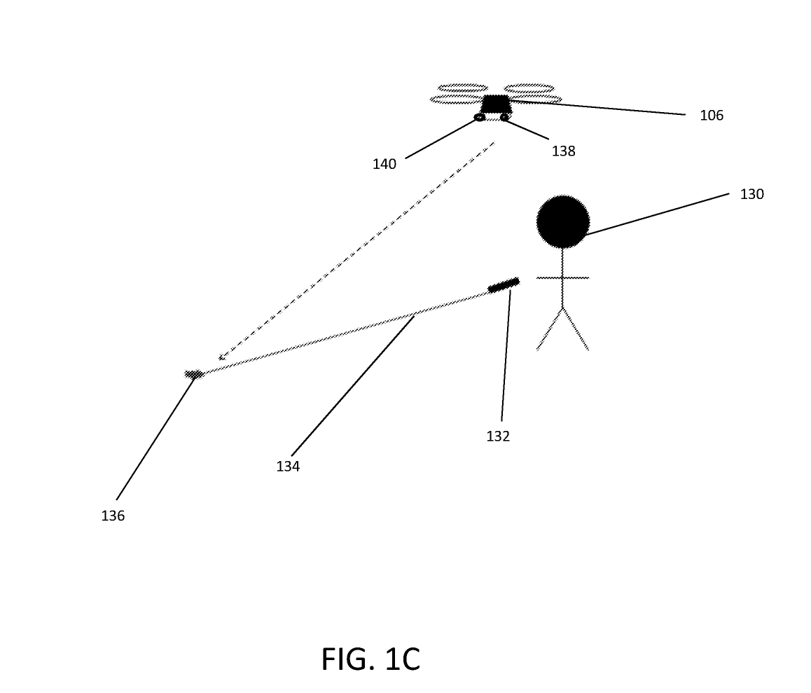

FIG. 1A is a block diagram illustrating an unmanned aerial vehicle (UAV) according to an exemplary embodiment. An autonomous UAV 106 may include an inertial navigation system and one or more storage units. The autonomous UAV can autonomously navigate aerially using motive assemblies 102. The motive assemblies 102 can be but are not limited to wheels, tracks, rotors, rotors with blades, and propellers The UAV 106 can include a body 100 and multiple motive assemblies 102. In this non-limiting example, the motive assemblies can be secured to the body on the edges of the UAV 106.

The body 100 of the UAV 106 can include a storage unit. The storage unit can include a delivery mechanism such as, but not limited to, a picking unit (not shown) such as electrically operated clamps, claw-type clips, hooks, electro-magnets or other types of grasping mechanisms. The UAV can include a controller 108a, and the inertial navigation system can include a GPS receiver 108b, accelerometer 108c and a gyroscope 108d. The UAV 106 can also include a motor 108e. The controller 108a can be programmed to control the operation of the GPS receiver 108b, accelerometer 108c, a gyroscope 108d, motor 108e, and drive assemblies 102 (e.g., via the motor 108e), in response to various inputs including inputs from the GPS receiver 108b, the accelerometer 108c, and the gyroscope 108d. The motor 108e can control the operation of the motive assemblies 102 directly and/or through one or more drive trains (e.g., gear assemblies and/or belts).

The GPS receiver 108b can be a L-band radio processor capable of solving the navigation equations in order to determine a position of the UAV 106, determine a velocity and precise time (PVT) by processing the signal broadcasted by GPS satellites. The accelerometer 180c and gyroscope 108d can determine the direction, orientation, position, acceleration, velocity, tilt, pitch, yaw, and roll of the UAV 106. In exemplary embodiments, the controller can implement one or more algorithms, such as a Kalman filter, for determining a position of the UAV.

The UAV 106 can be configured to pick up physical objects 104 (e.g. a pill bottle) using the picking unit. The size of the physical objects 104 can be proportionate to the size of the UAV 106. The UAV 106 can pick up and carry the physical object 104 to a predetermined location. In some embodiments, multiple UAVs can be configured to pick up a portion of a physical object and carry the physical object together, to a pre-determined location.

FIG. 1B is a block diagram illustrating a unloading pad for a UAV delivery in an exemplary embodiment. As mentioned above, the UAV 106 can autonomously navigate to a specified location. The UAV 106 can carry a physical object using a storage unit 122 and carry the physical object to the specified location. The UAV 106 can navigate to the specified location using motive assemblies 126. The UAV 106 can detect an unloading pad 124 upon reaching within a specified distance of the specified location. It will be appreciated that the unloading pad may be detected in a number of different ways by the UAV. For example, the unloading pad may have a scannable identifier affixed to the pad. Alternatively, the unloading pad may be identified at least in part using image recognition software on the UAV. Other identification techniques may also be employed by the UAV to identify the loading pad without departing from the scope of the present invention. The unloading pad 124 can be a surface of a specified area. The UAV 106 can be configured to hover over the unloading pad 124 at a specified distance and release the physical object from the storage unit 122 so that the physical object is unloaded on the unloading pad 124.

FIG. 1C illustrates a laser guided delivery for a UAV according to an exemplary embodiment. As mentioned above, the UAV 106 can carry a physical object using a storage unit and navigate to a specified location 136 based on received instructions. The UAV 106 can use an inertial navigation system (as shown above) to navigate to the specified location 136. In one embodiment, a user 130 using a laser device 132 can project a laser transmission 134 on a specified location 136. The laser device 132 can be coupled to, or integrated with, with a mobile device operated by the user. In another embodiment, the laser may be affixed in some manner to an object to project onto the designated location without a user being present. In some embodiments, the laser transmission 134 is visible to the unaided human eye. Alternatively, the laser transmission 134 may not part of the human visible spectrum. In some embodiments, the mobile device can execute a delivery module. The delivery module can detect the location of the UAV 106 and automatically control the laser transmission 134, in response to detecting that the UAV 106 is within specified threshold distance of the specified location 136. In one embodiment, the delivery module may communicate with the UAV 106 via the mobile device using Bluetooth® or WiFi communication, or another short or long-range communication protocol supported by both the UAV 106 and the mobile device 132.

The specified location 136 can be a surface on which the physical object being carried by the UAV 106, is designated to be unloaded. The UAV 106 can be coupled to a sensor 140. The sensor 140 can be configured to detect laser transmissions 140. As a non-limiting example, the sensor 140 can be a photoelectronic laser sensor. The UAV 106 can detect using the sensor 140, the laser transmission 134 on the specified location 136. The sensor 140 can identify the pulse and the frequency of the laser transmission 134 on the specified location 136. The UAV 106 can determine whether the pulse and frequency correspond with the instructions received by the UAV 106 in order to determine that the UAV is the intended recipient of the laser transmission. In response to determining the pulse and frequency correspond with the instructions received by the UAV 106 the UAV can deliver the physical object onto the surface of the specified location 136. In this manner, communication can be ensured with the correct UAV when there are multiple UAVs in the area. In some embodiments, UAV 106 can be configured to be within a predetermined distance and angle of the specified location 136 before delivering the physical object. In one embodiment, the UAV 106 can include a microphone 138. The microphone 138 can receive audio input from the user 130.

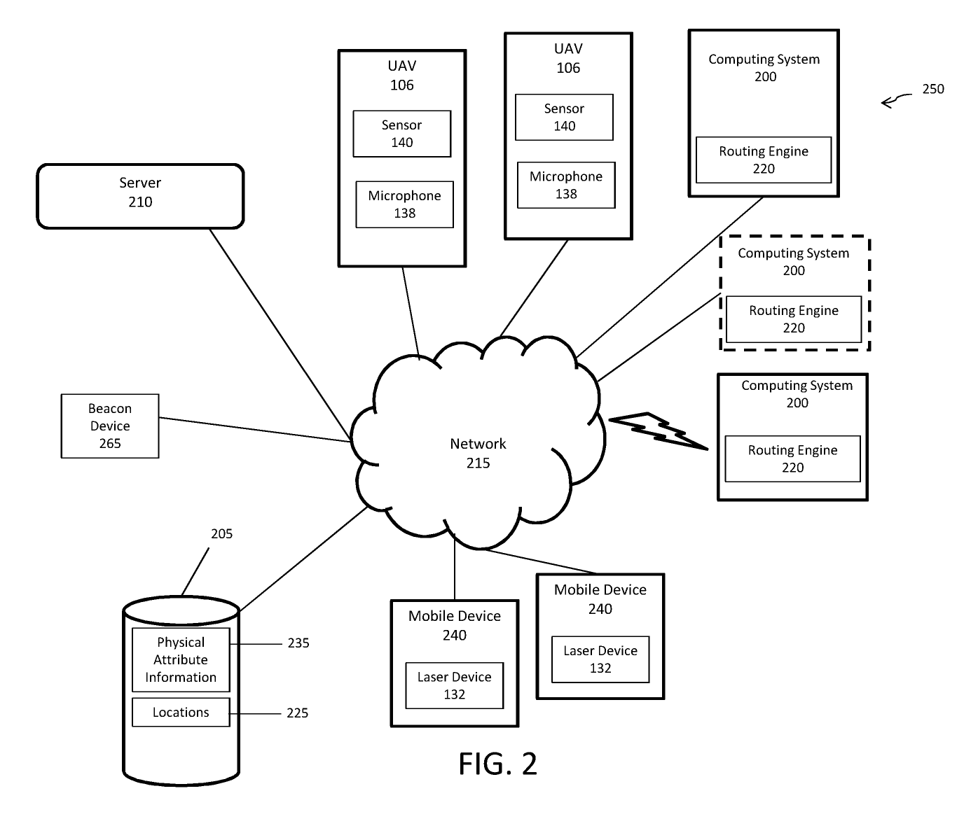

FIG. 2 is a block diagram illustrating an automated laser guided UAV delivery system according to an exemplary embodiment. The automated laser guided unloading system 250 can include one or more databases 205, one or more servers 210, one or more computing systems 200, one or more mobile devices 240, one or more beacon devices 265 and UAV 106. In exemplary embodiments, the computing system 200 can be in communication with the databases 205, the server(s) 210, the mobile devices 240, and the UAV 106, via a communications network 215. The computing system 200 can implement at least one instance of a routing engine 220. The mobile device 240 can include, or be coupled to, a laser device 132 configured to emit a laser transmission.

In an example embodiment, one or more portions of the communications network 215 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The computing system 200 includes one or more computers or processors configured to communicate with the databases 205, mobile devices 240, the beacon devices 265 and UAV 106 via the network 215. The computing system 200 hosts one or more applications configured to interact with one or more components of the automated laser guided unloading system 250. The databases 205 may store information/data, as described herein. For example, the databases 205 can include a locations database 225, physical attribute information database 230. The locations database 225 can include information associated with addresses and/or GPS coordinates of delivery locations. The physical attribute information database 230 can store information associated with appropriate surfaces for physical object unloading locations. The databases 205 and server 210 can be located at one or more geographically distributed locations from each other or from the computing system 200. Alternatively, the databases 205 can be included within server 210 or computing system 200.

In exemplary embodiments, the computing system 200 can receive instructions to retrieve one or more physical objects from a facility. The computing system 200 can execute the routing engine 220 in response to receiving the instructions. The instructions can include identifiers associated with the physical objects and a delivery location. The routing engine 220 can query the locations database 225 to retrieve the GPS coordinates of the delivery location. The physical objects can be retrieved and can be loaded onto one or more UAVs 106. In some embodiments, the routing engine 220 can instruct one or more UAVs 106 to navigate to the locations of the physical objects and to retrieve the physical objects from the facility.

The routing engine 220 can transmit instructions to the UAV 106 to navigate to a specified location based on the GPS coordinates and to unload the physical object loaded onto the UAV 106 at the specified location. The instructions can include a specified pulse and frequency of a laser transmission that are specific to a particular UAV. The routing engine 220 can also transmit instructions to a mobile device 240 that include the pulse and frequency information. The mobile device 240 can execute a delivery module. The UAV 106 can navigate to the specified location. The delivery module of the mobile device 240 can detect the UAV 106 is within a threshold distance of the specified location. The mobile device 240 can capture physical attributes associated with the surface of the specified location. In some embodiments, the mobile device 240 can capture an image of the surface of the specified location using an image capturing device. The delivery module can extract physical attributes associated with the surface of the specified location. The physical attributes can be one or more of size dimension, information about terrain of the surface and environmental conditions of the surface. The mobile device 240 can query the physical attributes information database 235 to retrieve a type of surface suitable for delivery of the physical object. The delivery module can also query the physical attribute information database 235 to determine the amount of area needed for delivering the physical object. The mobile device 240 can determine a suitable delivery surface for the physical objects based on the extracted attributes, and the retrieved type and area of surface suitable for unloading the physical object

In response to determining the UAV 106 is within a specified threshold distance of the specified location (such as by establishing a communication link), the mobile device 240 can control the laser device to emit a laser transmission on the determined suitable surface area of the specified location for delivery of the physical object. In some embodiments, the laser transmission can generate a shape covering the suitable area needed for delivering the physical object. The sensor 140 of the UAV 106 can detect the laser transmission which is being reflected off of the surface of the specified location. The sensor 140 can detect the pulse and frequency of the laser. The UAV 106 can determine whether the pulse and frequency correspond with the pulse and frequency received in the instructions in order to make sure the transmission is intended for this particular UAV. In response to determining that the pulse and/or frequency correspond with the pulse and/or frequency received in the instructions, the UAV 106 can navigate to a specified distance and angle of the surface and deliver the physical object onto the surface of the specified location. In some embodiments, the UAV 106 can also detect the shape created by the transmission of the laser device. In some embodiments, multiple laser devices can generate a sequence of multiple laser transmissions. The sequence can create multiple spectrums, pulses and/or patterns which are reflected off of the surface. The UAV 106 can detect the spectrums, pulses and patterns reflected off of the surface. For example, a laser device (s) might include three distinct lasers each coded to a different spectrum and pulse detectable by the UAV and the lasers themselves might osculate to make a pattern such as a single laser creating an oval or figure eight in a much smaller area.

In one embodiment, the UAV 106 can determine based on past deliveries to the same specified location that the surface of the specified location on which the laser transmission is emitted is not suitable for unloading the physical object. For example, the UAV may store records of previous locations marked as unsuitable. Alternatively, the sensor 140 can detect the surface on which the laser transmission is being emitted and determine the surface is not suitable for delivering the physical object. The UAV 106 can alert the routing engine 220 that the surface on which the laser transmission is being emitted is not suitable for unloading the physical object. The routing engine 220 can instruct the mobile device 106 to select a different surface of the specified location on which to emit the laser transmission. In some embodiments, the sensor 140 can detect an alternate suitable surface location for unloading the physical object. The UAV 106 can transmit the alternate location to the routing engine 220. The routing engine 220 can approve the alternate surface location and instruct the mobile device to emit a laser transmission onto the alternate surface location. In some embodiments, the UAV 106 can communicate with the mobile device 106 directly regarding the alternate location.

As a non-limiting example, the automated laser guided UAV delivery system 250 can be implemented in a retail store. The computing system 200 can receive instructions to retrieve one or more products from a retail store. The computing system 200 can execute the routing engine 220 in response to receiving the instructions. The instructions can include identifiers associated with the products and a delivery location. The delivery location can be a customer specified delivery location. The routing engine 220 can query the locations database 225 to retrieve the GPS coordinates of the delivery location. The products can be retrieved and can be loaded onto one or more UAVs 106. In some embodiments, the routing engine 220 can instruct one or more UAVs 106 to navigate to the locations of the products and to retrieve the products from the retail store.

The routing engine 220 can transmit instructions to the UAVs 106 to navigate to a specified location based on the GPS coordinates and to deliver the products loaded onto the UAV 106 at the specified location. The instructions can include a specified pulse and frequency of a laser transmission that should be identified at the delivery location before delivery takes place. The routing engine 220 can transmit instructions to a mobile device 240t hat is executing a delivery module as described herein. The UAV 106 can navigate to a specified location. The delivery module of the mobile device 240 can detect that the UAV 106 is within a threshold distance of the specified location. For example, the delivery module may detect that the UAV has come within communication range. The mobile device 240 can capture physical attributes associated with the surface of the specified location. In some embodiments, the mobile device 240 can capture an image of the surface of the specified location using an image capturing device. The delivery module can extract physical attributes associated with the surface of the specified location. The physical attributes can be one or more of size dimension, information about terrain of the surface and environmental conditions of the surface. The mobile device 240 can query the physical attributes information database 235 to retrieve a type of surface suitable for the physical object. The mobile device 240 can also query the physical attribute information database 235 to determine the amount of area needed for unloading/delivering the product. The mobile device 240 can determine a suitable delivery surface for the products based on the extracted attributes and the retrieved type and area of surface needed for unloading the product.

In response to determining that the UAV 106 is within a specified threshold distance of the specified location, the mobile device 240 can control the laser device to emit a laser transmission on the determined suitable surface area of the specified location for unloading the product. In some embodiments, the laser transmission can generate a shape covering the suitable area needed for unloading the product. The sensor 140 of the UAV 106 can detect the laser transmission on the surface of the specified location. The sensor 140 can detect the pulse and frequency of the laser. The UAV 106 can determine whether the pulse and/or frequency correspond with the pulse and/or frequency received in the instructions. In response to determining, that the pulse and/or frequency correspond with the pulse and/or frequency received in the instructions, the UAV 106 can navigate to a specified distance and angle of the surface and deliver the product onto the surface of the specified location. As a non-limiting example, the specified location can be a kiosk disposed in a retail store.

In some embodiments, the UAV 106 can determine based on past deliveries to the same specified location that the surface of the specified location on which the laser transmission is emitted is not suitable for unloading the product. The UAV 106 can alert the routing engine 220 that the surface on which the laser transmission is being emitted is not suitable for unloading the product. The routing engine 220 can instruct the mobile device 106 to select a different surface of the specified location on which to emit the laser transmission. In some embodiments, the UAV 106 can transmit the alert to the mobile device 106 directly.

In some embodiments, the UAV 106 can receive voice/audio input through a microphone 138. For example, a microphone 138 can be disposed on the UAV 106. The sensor 140 of the UAV 106 can detect the laser transmission on the surface of the specified location. The UAV 106 can receive a voice/audio input through the microphone 138. The UAV 106 can use voice/audio recognition software to verify the voice/audio input. The UAV 106 can verify the specified location is suitable for unloading the product based on the verification of the voice/audio input. The voice recognition software can be one or more of, CMU Sphinx, Mozilla DeepSpeech, HTK, Julius, Kaldi, iATROS, RWTH ASR, wav2letter, Agnito, Simon, Jasper project, Dragon Dictate, iListen, ViaVoice, or Voice Navigator.

In another embodiment, a beacon device 265 can be disposed within a specified distance of the specified location. The beacon device 265 can emit a signal. The signal can include a unique identifier associated with the beacon device 265. The sensor 140 can the laser transmission on the surface of the specified location and the signal emitted by the beacon device 265. The sensor 140 can extract the unique identifier from the signal emitted by the beacon device 265. The sensor 140 can transmit the unique identifier the computing system 200. The computing system 200 can verify the unique identifier and transmit a verification message to the UAV 106. The UAV 106 can verify the is suitable for unloading the product based on the verification of the unique identifier by the computing system 200. As an example, the sensor 106 can use Bluetooth® technology to detect the signal emitted by the beacon device 265.

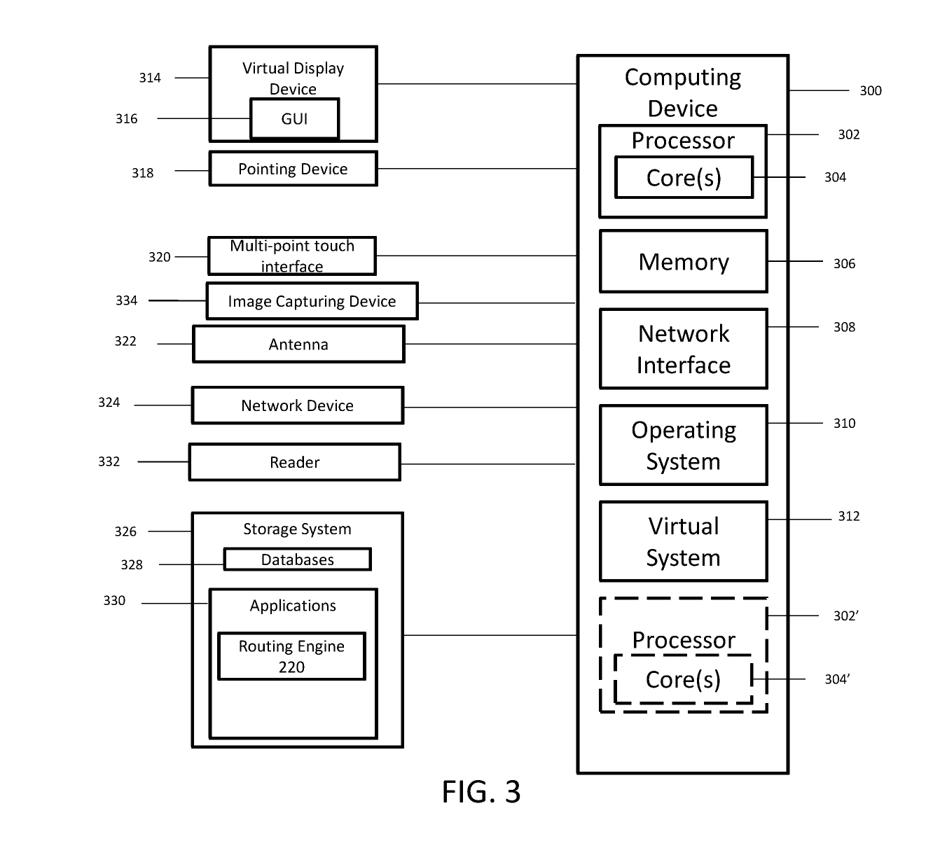

FIG. 3 is a block diagram of an exemplary computing device suitable for use in an embodiment. Computing device 300 can execute the routing engine described herein. The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 306 included in the computing device 300 may store computer-readable and computer-executable instructions or software (e.g., applications 330 such as the routing engine 220) for implementing exemplary operations of the computing device 300. The computing device 300 also includes configurable and/or programmable processor 302 and associated core(s) 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for implementing exemplary embodiments of the present disclosure. Processor 302 and processor(s) 302′ may each be a single core processor or multiple core (304 and 304′) processor. Either or both of processor 302 and processor(s) 302′ may be configured to execute one or more of the instructions described in connection with computing device 300.

Virtualization may be employed in the computing device 300 so that infrastructure and resources in the computing device 300 may be shared dynamically. A virtual machine 312 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, EDO RAM, and the like. Memory 306 may include other types of memory as well, or combinations thereof.

A user may interact with the computing device 300 through a visual display device 314, such as a computer monitor, which may display one or more graphical user interfaces 316, multi touch interface 320, a pointing device 318, an image capturing device 334 and an sensor 332.

The computing device 300 may also include one or more storage devices 326, such as a hard-drive, CD-ROM, or other computer readable media, for storing data and computer-readable instructions and/or software that implement exemplary embodiments of the present disclosure (e.g., applications). For example, exemplary storage device 326 can include one or more databases 328 for storing information associated with types of suitable unloading surfaces for physical objects and information associated with delivery locations. The databases 328 may be updated manually or automatically at any suitable time to add, delete, and/or update one or more data items in the databases.

The computing device 300 can include a network interface 308 configured to interface via one or more network devices 324 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 322 to facilitate wireless communication (e.g., via the network interface) between the computing device 300 and a network and/or between the computing device 300 and other computing devices. The network interface 308 may include a built-in network adapter, network interface card, PCMCIA network card, card bus network adapter, wireless network adapter, USB network adapter, modem or any other device suitable for interfacing the computing device 300 to any type of network capable of communication and performing the operations described herein.

The computing device 300 may run any operating system 310, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or any other operating system capable of running on the computing device 300 and performing the operations described herein. In exemplary embodiments, the operating system 310 may be run in native mode or emulated mode. In an exemplary embodiment, the operating system 310 may be run on one or more cloud machine instances.

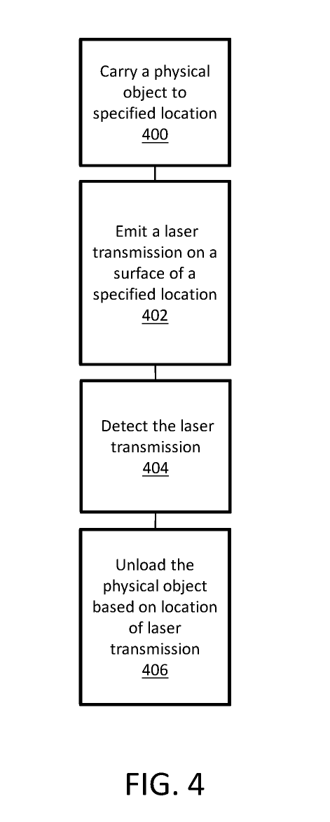

FIG. 4 is a flowchart illustrating an exemplary process performed by an automated laser guided UAV delivery system in accordance with an exemplary embodiment. In operation 400, a UAV (e.g. UAV 106 as shown in FIGS. 1A-2) carrying a physical object in a storage unit (e.g. storage unit 122 as shown in FIG. 1B), autonomously aerially navigates towards a specified location. The UAV includes an inertial navigation system (e.g. inertial navigation system 108a-e as shown in FIG. 1A) and a sensor (e.g. sensor 140 as shown in FIG. 1C and 2). In operation 402, a laser device (e.g. laser device 132 as shown in FIG. 1C and 2) emits a laser transmission (e.g. laser transmission 134 as shown in FIG. 1C) on a surface of a specified location (e.g. specified location 136 as shown in FIG. 1C). In operation 404, the UAV detects, via the sensor, the laser transmission emitted on the surface of the specified location. The UAV can detect the frequency and pulse of the laser transmission. In operation 406, the UAV can unload the physical object from the storage unit onto the surface of the specified location on which the laser transmission is being emitted based on the detected frequency and/or pulse.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. An unmanned aerial vehicle (UAV) delivery system comprising:
a laser device configured to emit a laser transmission onto a surface of a specified location;
at least one autonomous UAV that includes:
an inertial navigation system,
a sensor for detecting the laser transmission, and
one or more storage units configured to store one or more physical objects; and
a delivery module, the delivery module executable on a mobile device equipped with a processor and configured to:
control the laser device to alter at least one of a frequency and pulse of the laser transmission so as to communicate with the at least one autonomous UAV,
wherein the at least one autonomous UAV is configured to:
carry one or more physical objects in the one or more storage units,
detect, via the sensor, the laser transmission on the surface of the specified location,
identify one of the pulse and frequency of the laser transmission as being directed to the at least one autonomous UAV, and
deliver, based on the identifying, the one or more physical objects onto the surface of the specified location.

2. The system of claim 1, wherein the laser transmission is generated in response to the at least one autonomous UAV communicating with the delivery module executing on the mobile device.

3. The system of claim 1, wherein the laser transmission is visible to an unaided human eye.

4. The system of claim 1 wherein the laser transmission is not part of the human visible spectrum.

5. The system of claim 1, further comprising:
a mobile device coupled to or including the laser device and communicatively coupled to the at least one autonomous UAV, the mobile device configured to determine a set of attributes associated with the surface of the specified location and to transmit the attributes to the at least one autonomous UAV.

6. The system of claim 5, wherein the set of attributes can include at least one of a type, a size, a dimension, information about a terrain of the surface, and environmental conditions of the surface.

7. The system of claim 5, wherein the mobile device is configured to store an exact location of the laser transmission on the surface of the specified location.

8. The system of claim 5, wherein the mobile device is configured to detect that the at least one autonomous UAV is within a predetermined distance of the mobile device and to control the operation of the laser device to emit the laser transmission onto the surface of the specified location in response to detecting that the at least one autonomous UAV is within a predetermined distance of the mobile device.

9. An autonomous unmanned aerial vehicle (UAV) delivery method comprising:
aerially navigating at least one autonomous UAV towards a specified location , the at least one autonomous UAV including an inertial navigation system, a sensor, and one or more storage units;
carrying, with the at least one autonomous UAV, one or more physical objects in the one or more storage units;
detecting, via the at least one autonomous UAV, using the sensor, at least one of a pulse or frequency of the laser transmission on a surface of the specified location;
delivering, from the at least one autonomous UAV, the one or more physical objects onto the surface of the specified location based on the detecting.

10. The method of claim 9, wherein the laser transmission is generated in response to the at least one autonomous UAV communicating with a delivery module executing on a mobile device used to control a laser device.

11. The method of claim 9, wherein the laser transmission is visible to an unaided human eye.

12. The method of claim 9 wherein the laser transmission is not part of the human visible spectrum.

13. The method of claim 9, further comprising:
determining, via a mobile device including a laser device and communicatively coupled to the at least one autonomous UAV, a set of attributes associated with the surface of the specified location, the set of attributes transmitted to the at least one autonomous UAV.

14. The method of claim 13, wherein the set of attributes can include, at least one of a type, a size, a dimension, information about the terrain of the surface, and environmental conditions of the surface.

15. The method of claim 13, further comprising:
storing, via the mobile device, an exact location of the laser transmission on the surface of the specified location.

16. The method of claim 13, further comprising:
detecting, with the mobile device, that the at least one autonomous UAV is within a predetermined distance of the mobile device; and
controlling, via the mobile device, operation of the laser device to emit the laser transmission onto the surface of the specified location in response to detecting that the at least one autonomous UAV is within a predetermined distance of the mobile device.

17. An unmanned aerial vehicle (UAV) delivery system comprising:
a laser device configured to emit a laser transmission onto a surface of a suggested location;
a plurality of autonomous UAVs that include:
a sensor for detecting the laser transmission, and
one or more storage units configured to store one or more physical objects; and
a delivery module, the delivery module executable on a mobile device equipped with a processor and configured to:
control the laser device to communicate with at least one autonomous UAV, wherein the selected one of the plurality of autonomous UAVs is configured to:
carry one or more physical objects in the one or more storage units,
detect, via the sensor, the laser transmission on the surface of the suggested location,
identify another location within a predetermined distance of the suggested location as an alternate delivery location;
transmit the alternate location to the delivery module;
receive an approval of the alternate location from the delivery module; and
deliver, based on the approval, the one or more physical objects at the alternate location instead of the suggested location.

18. The system of claim 17 wherein the selected one of the plurality of UAVs includes image sensors and the alternate location is identified based on an image analysis performed by the selected one of the plurality of UAVs of image data acquired with the image sensors.

19. The system of claim 17, wherein the laser transmission is visible to an unaided human eye.

20. The system of claim 17 wherein the laser transmission is not part of the human visible spectrum.
